(19) United States
(12) Patent Application Publication
(10) Pub. No.: US 2026/0034605 A1
(43) Pub. Date: Feb. 5, 2026

(54) DEVICE AND METHOD FOR MANUFACTURING PRINTED CIRCUIT BOARDS

(71) Applicant: PETR VYACHESLAVOVICH SEVOSTIANOV, Limassol (CY)

(72) Inventors: PETR VYACHESLAVOVICH SEVOSTIANOV, Limassol (CY); SERGEI OMELCHENKO, Limassol (CY)

(21) Appl. No.: 18/791,914

(22) Filed: Aug. 1, 2024

(51) Int. Cl. B23K 26/03; B23K 26/042; B23K 26/10; B23K 26/12; B23K 26/362; B23K 101/42

(52) U.S. Cl. CPC B23K 26/032; B23K 26/042; B23K 26/10; B23K 26/125; B23K 26/127; B23K 26/362; B23K 2101/42

(57) ABSTRACT

An apparatus for printed circuit board manufacturing comprises a housing, a worktable containing multiple optical sensors and providing placement and fixation of a PCB blank, a laser unit containing a laser source, a collimator, a scanning system, and a focusing system, and configured to remove a material layer from the PCB blank, and a controller configured to determine position of the PCB blank and provide calibration of the laser unit using optical sensors. A method of calibrating the apparatus for printed circuit board manufacturing involves determining position of each optical sensor in the laser beam coordinate system with successive refinement of this position and determining a coordinate transformation function that links coordinates of the optical sensors in the laser beam coordinate system with coordinates of these sensors in the apparatus coordinate system.

### TECHNICAL FIELD

The invention relates to the field of printed circuit board (PCB) assembly technologies in electronics. More particularly, the invention is intended for rapid production of PCB prototypes in laboratory, office or home conditions using laser ablation and without use of reagents and equipment for chemical metal etching.

### CONVENTIONAL ART

There are several types of equipment for rapid production of PCB prototypes. Some technologies are based on mechanical removal (milling) of the PCB metal conductor layer to form a conductive pattern. In other technologies, the removal (ablation) of the metal conductor layer is performed using a laser beam. Some other technologies involve application of conductive paste with simultaneous or subsequent heating to form a conductive pattern. Each of these technologies has its own advantages and disadvantages, which determine the scope of its application and prevalence in the market.

A method for forming a PCB conductive pattern is known from U.S. Pat. No. 5,293,025 A, in which laser is used to punch holes in the dielectric material, and the conductive pattern is formed using thick-film technology. Laser removal of the conductive layer is not provided.

A method for forming a conductive pattern on flexible RFID tags is known from U.S. Pat. No. 5,800,724 A, in which metal foil on a specified portion of the substrate is removed by laser irradiation. The method is not intended for manufacturing rigid PCBs.

A PCB blank is known from U.S. Pat. No. 5,840,402 A, in which both sides of an insulating layer are covered with conductive layers electrically connected by conductive through-holes formed by laser drilling. A method of further forming the conductive pattern is not described.

A method for forming a PCB conductive pattern is known from U.S. Pat. No. 7,271,099 B2, in which metal foil on a specified portion of the board is removed by laser processing. In this case, the specified areas are narrow strips separating the foil areas forming the conductive pattern and the foil areas to be further removed by chemical etching. Laser removal of the metal foil on areas of significant size is not provided.

A method for forming a conductive pattern on a flexible PCB with integrated circuit elements is known from U.S. Pat. No. 7,709,766 B2, in which the conductive material on a specified portion of the substrate is removed by laser engraving. The method is not intended for manufacturing rigid PCBs.

A method for forming a PCB conductive pattern is known from U.S. Pat. No. 9,706,652 B2, in which laser radiation is used to providing windows in the mask layer and the photoresist layer on surface of the metal-plated insulating material. Laser removal of metal is not provided.

A method for generating a laser beam for laser engraving is known from US Patent Publication No. 2006065640 A1, which describes equipment for generating laser beam with the required temporal, energy, and geometric parameters. No method of forming a conductive pattern is described.

A method for controlling a laser beam for laser engraving is known from Patent Document US Patent Publication No. 20150251272 A1, which describes precise positioning of laser beam using structural markers read by a camera. No method of forming a conductive pattern is described.

A method for forming a PCB conductive pattern is known from RU U.S. Pat. No. 2,458,492 C2, in which metal foil on a specified portion of the board is removed by chemical etching, laser processing, ion bombardment, or particle jet processing. In this case, the specified areas are narrow strips separating foil areas forming the conductive pattern, and these foil areas are further removed mechanically. Laser removal of the metal foil on areas of significant size is not provided.

A method for forming a PCB conductive pattern is known from RU U.S. Pat. No. 2,543,518 C1, in which a metal protective layer and a wax mask layer are applied to the conductive layer, which are further removed by laser irradiation at a specified portion of the board, and then the conductive layer is selectively removed by chemical etching in areas without the protective layer and mask layer. Laser removal of the conductive layer to its full depth is not provided.

A method for forming a PCB conductive pattern is known from RU U.S. Pat. No. 2,593,267 C2, in which a layer of conductive paste on a ceramic substrate is removed by laser irradiation, and then the remaining paste is subjected to sintering. Laser removal of the pre-formed conductive layer is not provided.

A method for forming a PCB conductive pattern is known from SU U.S. Pat. No. 1,718,487 A1, in which a laser is used to punch holes in a dielectric material coated with copper. Laser radiation with different wavelengths is used to remove the copper and dielectric material. Laser removal of copper on areas of significant size is not provided.

There are known laser engraving systems on the market, which are manufactured by CIF (France), GCC (Taiwan), and LPKF (Germany) and capable of providing windows in a photoresist layer and/or removing a metal layer from various foil-based insulation materials.

### SUMMARY OF THE INVENTION

There is a demand in the market for desktop equipment for PCB prototyping in industrial, laboratory, office, educational, and even residential settings, under usual ventilation conditions, using a commercially available laser and without the use of reagents and equipment for chemical metal etching.

The problem of fast and user-friendly production of PCB prototypes is solved by the concepts described herein, which includes an apparatus for PCB manufacturing, a method for processing PCB blanks in the apparatus, a method of calibrating the apparatus, and a PCB blank to be processed in the apparatus.

The apparatus for PCB manufacturing comprises a housing, a worktable, a laser unit, and a controller. The worktable may be a movable worktable. It receives and secures the PCB blank in a first orientation and a second orientation being different from the first orientation. The first and second orientations of the PCB blank can be selected such that processing initiated in the first orientation can be continued in the second orientation with required processing accuracy.

The worktable may include multiple optical sensors. The controller is capable of calibrating the laser unit using the optical sensors. The controller is capable of determining position of the PCB blank using the optical sensors.

The laser unit may comprise a laser radiation source, a collimator, a scanning system, and a focusing system. The laser unit is capable of removing a layer of material from the PCB blank. The layer of material may include at least one of the following materials: metal, ceramic, glass-ceramic (vitroceramic, pyroceramic) material, polymer-ceramic composite, polymer-glass composite, organic polymer composite, polymer.

The apparatus may further comprise a filtration unit that provides for filtering a gaseous medium inside the housing. In this case, the gaseous medium may circulate within a working volume inside the housing. The gaseous medium may comprise air.

The apparatus is capable of performing at least one of the following actions: providing a window in a protective mask, removing a conductor layer from an insulating base of the PCB blank, creating recesses in the PCB blank, creating through-holes in the PCB blank, trimming the PCB blank along a contour of a predetermined shape.

The method of processing the PCB blank by the PCB manufacturing apparatus includes the following steps:
placing and securing the PCB blank in the first orientation on the worktable of the apparatus;
optionally performing calibration of the laser unit;
transmitting, to the apparatus, data about connections and contact pads;
evaporating a portion of a conductive layer using a laser beam to form the connections and the contact pads on the PCB blank.

The worktable may be moved to a PCB blank loading position before placing and securing the PCB blank, and to a working position after placing and securing the PCB blank.

The method may further include evaporating a portion of a protective mask layer using the laser beam to form the contact pads on the PCB.

The method may further include evaporating a portion of the insulating base using the laser beam to form at least one of the following: a hole, a recess, a notch, an outer contour of the PCB blank.

The method may further include cleaning (filtering) the gaseous medium in the working volume of the apparatus during evaporation of the PCB blank material.

After processing the PCB blank in the first orientation, the PCB blank can be placed and secured in the second orientation being different from the first orientation, and processing of this PCB blank may be continued in the second orientation. Placing and securing the PCB blank in the second orientation may be performed with or without its extraction from the PCB manufacturing apparatus.

The calibration method of the PCB manufacturing apparatus comprises the following steps:
determining a position of at least two optical sensors in a laser beam coordinate system;
determining a coordinate transformation function.

Determining position of each optical sensor in the laser beam coordinate system may include the following steps:
approximate determination of the position of each optical sensor;
first refinement of the position determined in the previous step;
second refinement of the position determined in the previous step.

Determining the position of each optical sensor in the laser beam coordinate system can be performed sequentially or simultaneously along two coordinates in an apparatus coordinate system. Determining the position of each optical sensor in the laser beam coordinate system can be carried out while changing position of the laser beam sequentially or simultaneously along two coordinates in the apparatus coordinate system.

The first refinement of the position may be performed using a “crisscross” method. The second refinement of the position may be performed using a “circular” method.

The coordinate transformation function may associate or link the coordinates of the sensors in the laser beam coordinate system with the coordinates of these sensors in the apparatus coordinate system.

The PCB blank comprises the insulating base with at least one conductive layer. The PCB blank may contain multiple mounting elements. The PCB blank may contain multiple metal-plated through-holes. Additionally, the blank may contain the protective mask layer.

The insulating base may be made of a material based on at least one of the following: ceramic, glass-ceramic material, polymer-ceramic composite, polymer-glass composite, polymer-organic composite, polymer. Thickness of the insulating base may range from about 0.5 mm to about 5 mm.

The conductive layer may be made of a metal-based material and may include at least one of the following metals: silver, copper, aluminum, nickel, chromium. The thickness of the conductive layer may range from about 5 μm to about 60 μm.

The protective mask layer may be made of a material based on at least one of the following: a dry film photoresist and a liquid photoresist. The thickness of the protective mask layer may range from about 5 μm to about 100 μm.

The blank may contain at least two conductive layers, where the metal-plated through-holes electrically connect portions of the conductive layers. At least one conductive layer may be a solid conductive layer, and at least one conductive layer may be a mesh conductive layer.

The PCB blank may contain two sets of metal-plated through-holes. The first set is located along at least one side of the blank and the second set is located in a free area of the blank. Diameter of the metal-plated through-holes of the first set may differ from diameter of the metal-plated through-holes of the second set. Diameter of the metal-plated through-holes of the first set may range from about 0.25 mm to about 3 mm. Diameter of the metal-plated through-holes of the second set may range from about 0.1 mm to about 1.0 mm. The pitch of the metal-plated through-holes of the first set may differ from the pitch of the metal-plated through-holes of the second set.

The mounting elements of the blank may represent holes with diameter ranging from about 1.0 mm to about 10.0 mm, slots of a predetermined shape, and/or edge areas of the PCB.

The blank may be intended for manufacturing one of the following: a single-side printed circuit board, a double-side printed circuit board and a multilayer printed circuit board.

The scope of invention also covers a method of calibrating any apparatus that uses laser radiation, the method comprising substantially the same steps and features as the calibration method of the PCB manufacturing apparatus as described above. Such an apparatus may be used for, e.g., laser ablation, laser drilling, laser engraving, laser cutting, laser welding, laser cleaning, laser oxidation, laser heat treatment, etc.

This allows for fast (within a few minutes) and easy (with a few button klicks) manufacturing prototype samples of single-sided, double-sided, and multilayer PCBs, including complex ones, which involve dense population of electronic components mounted both in the holes and on the surface of the PCB. The equipment for manufacturing thereof can be placed in industrial, laboratory, office, educational, or even residential premises having regular ventilation conditions.

Examples of implementing the invention are further described with reference to the accompanying drawings.

### BRIEF DESCRIPTION OF THE ATTACHED DRAWINGS

The accompanying drawings, which are included to provide a further understanding of the invention and are incorporated in and constitute a part of this specification, illustrate embodiments of the invention and together with the description serve to explain the principles of the invention.

### In the Drawings:

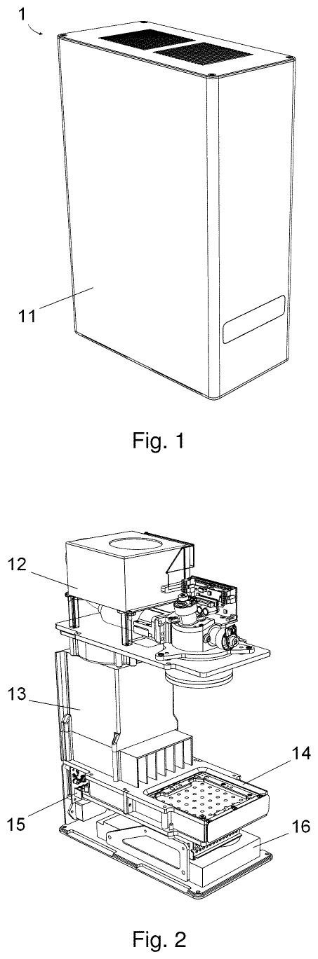

FIG. 1 depicts the desktop apparatus for rapid manufacturing PCB prototypes for electronic products.

FIG. 2 depicts the apparatus of FIG. 1 with its casing and top cover removed.

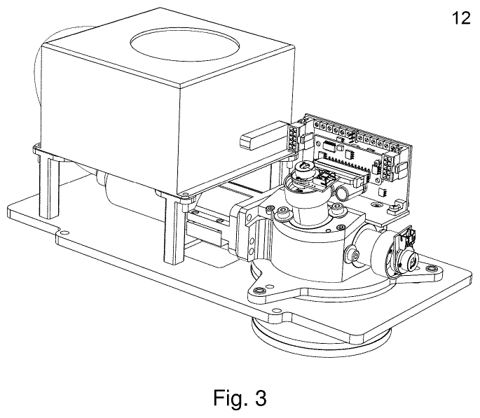

FIG. 3 depicts the laser unit of the apparatus of FIG. 2.

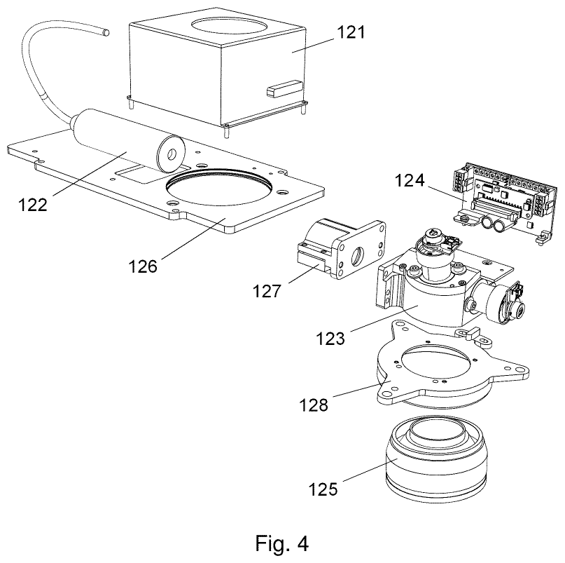

FIG. 4 depicts the laser unit of the apparatus in exploded view.

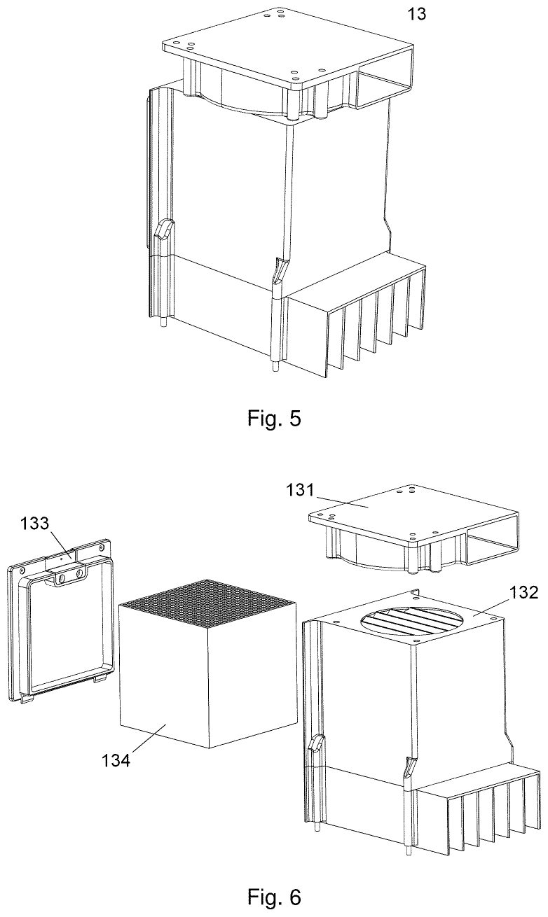

FIG. 5 depicts the air filtration unit of the apparatus of FIG. 2.

FIG. 6 depicts the air filtration unit of the apparatus in exploded view.

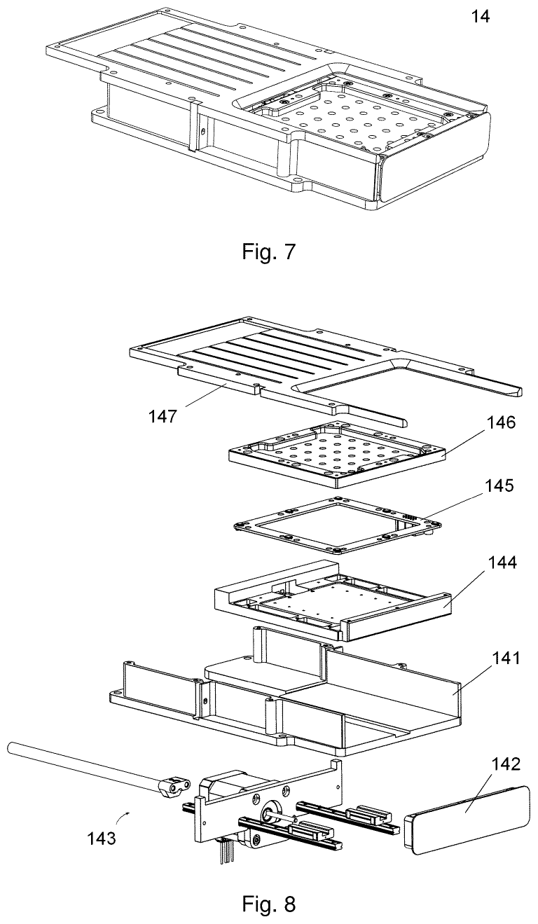

FIG. 7 depicts the movable worktable of the apparatus of FIG. 2.

FIG. 8 depicts the movable worktable of the apparatus in an exploded view.

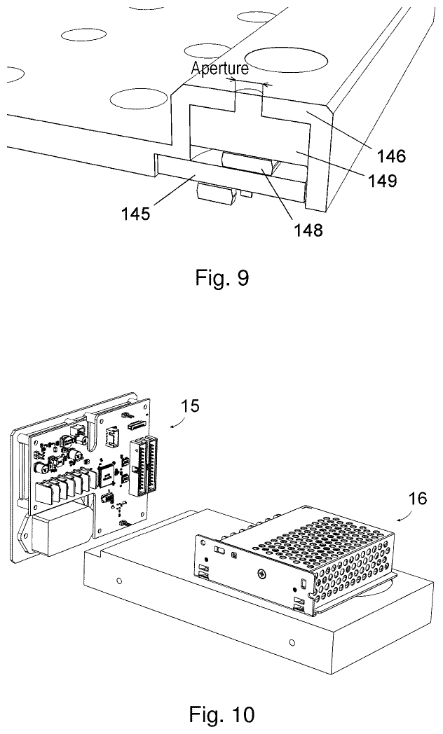

FIG. 9 depicts configuration of an optical sensor.

FIG. 10 depicts the controller and the power supply unit of the apparatus of FIG. 2.

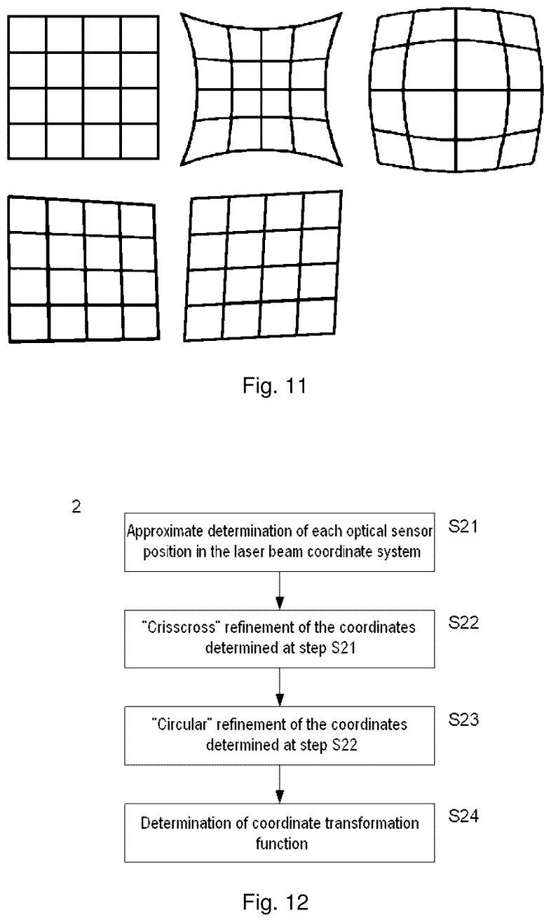

FIG. 11 depicts examples of possible geometric distortions of the laser beam path.

FIG. 12 depicts a block diagram of the laser unit calibration algorithm.

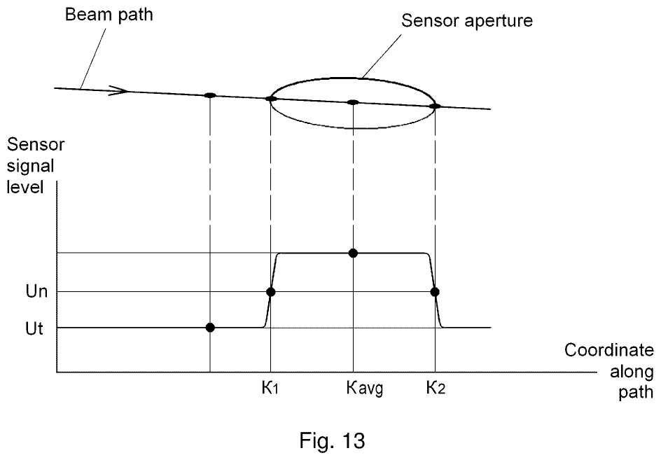

FIG. 13 illustrates determination of the optical sensor position, based on the average coordinate value. The sensor aperture is shown in a perspective view, as in FIG. 9.

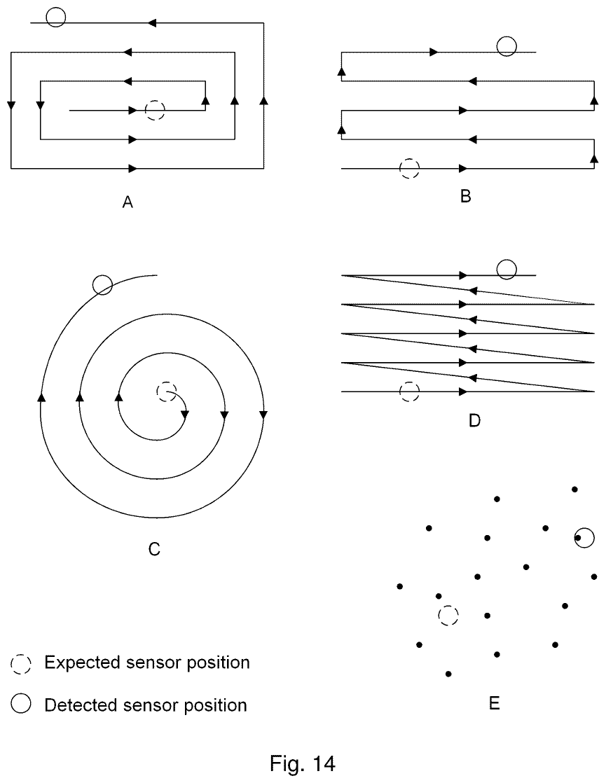

FIG. 14 depicts variants of the beam movement trajectory during approximate determination of the optical sensor position.

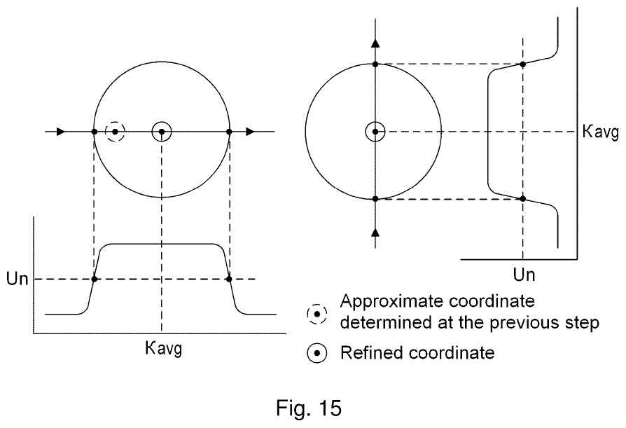

FIG. 15 illustrates the “crisscross” method of coordinate refinement.

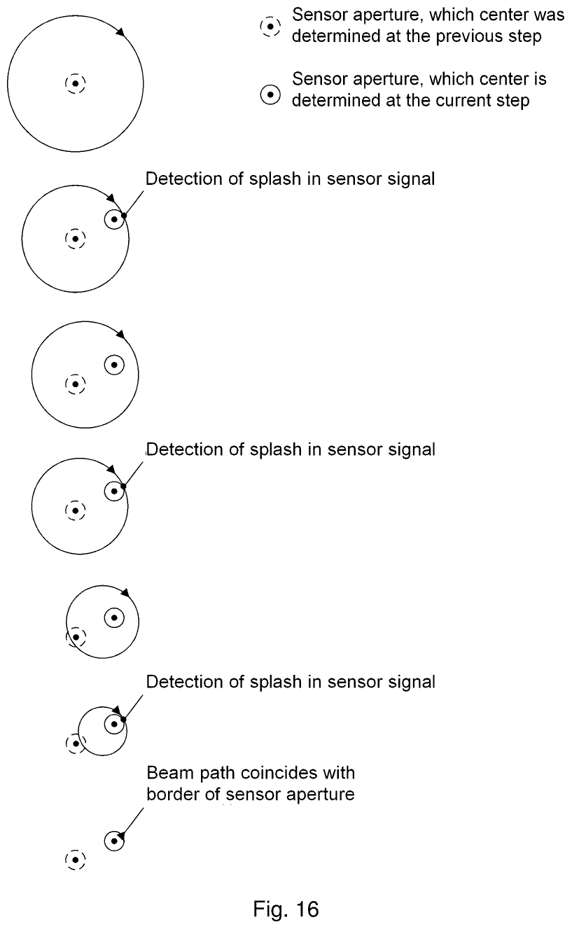

FIG. 16 illustrates the “circular” method of coordinate refinement.

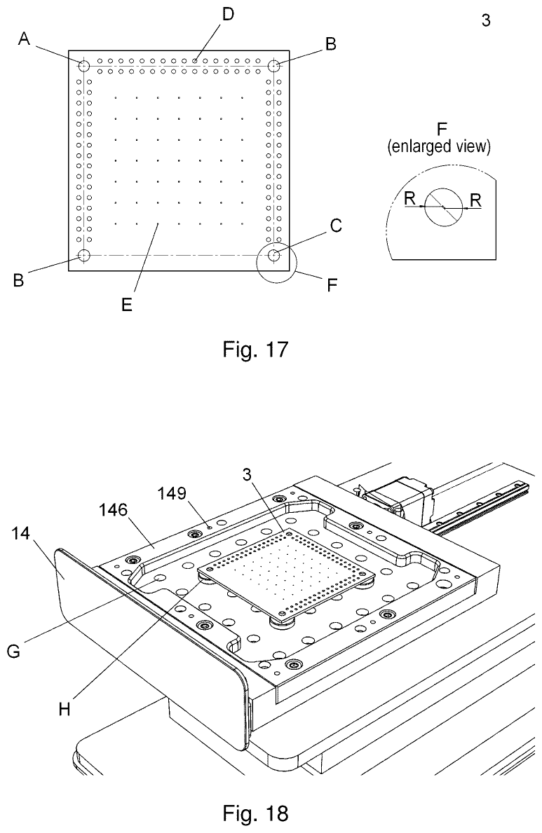

FIG. 17 depicts configuration of the PCB blank.

FIG. 18 illustrates positioning and fixation of the PCB blank on the movable worktable.

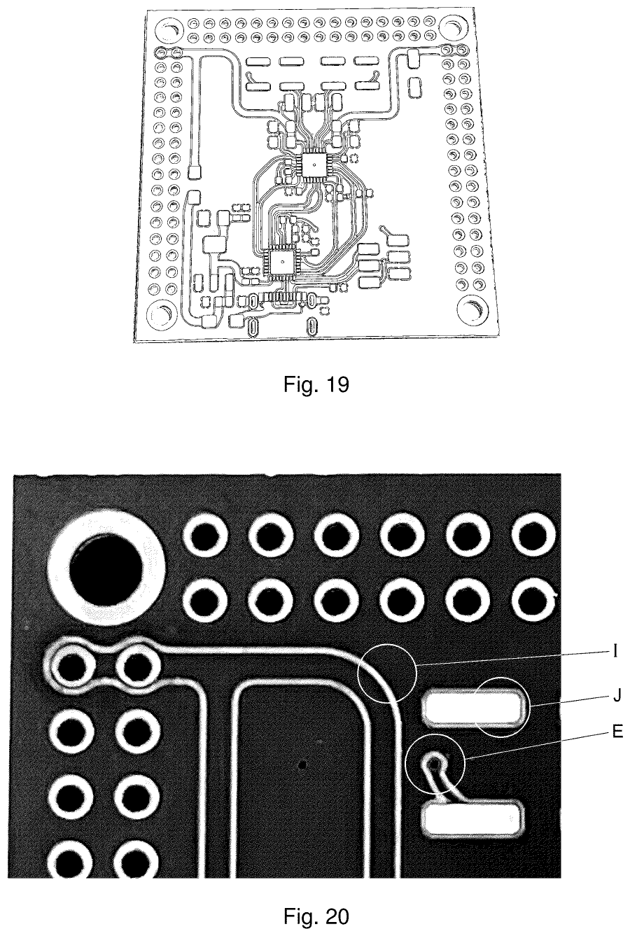

FIG. 19 depicts an example of a PCB manufactured from the blank using the apparatus according to the invention.

FIG. 20 depicts an enlarged portion of the PCB of FIG. 19.

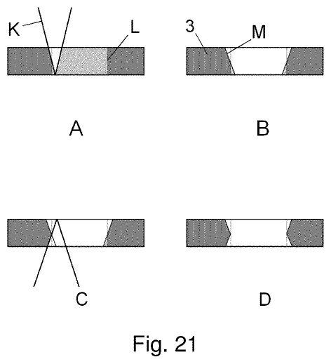

FIG. 21 illustrates laser drilling a through-hole in the PCB.

### DETAILED DESCRIPTION OF EMBODIMENTS OF THE INVENTION

Reference will now be made in detail to the preferred embodiments of the present invention, examples of which are illustrated in the accompanying drawings.

List of Designations

| | |
|---|---|
| 1 | apparatus according to the invention |
| 2 | method of calibrating laser unit |
| 3 | printed circuit board blank |
| 11 | housing |
| 12 | laser unit |
| 13 | air filtration unit |
| 14 | worktable |
| 15 | controller |
| 16 | power supply |
| 121 | laser source |
| 122 | collimator |
| 123 | scanning system |
| 124 | control device |
| 125 | focusing system |
| 126 | base |
| 127 | collimator holder |
| 128 | focusing system holder |
| 131 | fan |
| 132 | filter housing |
| 133 | filter cover |
| 134 | filtering element |
| 141 | worktable housing |
| 142 | front panel of worktable |
| 143 | worktable drive |
| 144 | worktable base |
| 145 | printed circuit board with optical sensors |
| 146 | worktable plate |
| 147 | worktable cover |
| 148 | optical sensor |
| 149 | optical sensor insert |
| A | mounting hole |
| B | mounting hole |
| C | mounting hole |
| D | metal-plated through-hole |
| E | metal-plated through-hole |
| F | mounting hole shape |
| G | worktable plate hole |
| H | pillar |
| I | insulating gap |
| J | contact pad |
| K | laser beam |
| L | cylindrical hole wall |
| M | conical hole wall |

The invention, in one embodiment, includes a desktop apparatus for fast prototyping PCBs intended for electronic device prototypes, and a PCB blank. The apparatus enables the following technological operations: opening windows in the protective photoresist mask (solder mask), removing the conductor layer from the surface of the PCB insulating base, creating recesses in the PCB insulating base, making through-holes in the PCB, and trimming the PCB to a predetermined shape. Laser irradiation is used to perform these technological operations.

Design features, operational characteristics, and principles of operation of an illustrative embodiment of the invention and other options are described below.

### Apparatus Design

Configuration of the apparatus (1) according to the invention is shown in FIGS. 1 and 2. FIG. 1 depicts an overall view of the assembled apparatus (1). For clarity, FIG. 2 shows the apparatus (1) without its casing and top cover. The apparatus (1) comprises the housing (11), the laser unit (12), the air filtration unit (13), the movable worktable (14) with a drive, the controller (15), and the power supply (16).

The housing (11) is a combination of load-bearing and enclosing structures of the apparatus. In the illustrative embodiment of the invention, it consists of a casing, a top cover, and a bottom cover. In other embodiments of the invention, the housing (11) may be of a different design to accommodate and secure other elements of the apparatus (1) and isolate the working volume of the apparatus (1) from the external environment to ensure effective filtration of the gaseous medium within the working volume. The elements of the housing (11) can be made of metal (e.g., steel or aluminum alloys), plastic (e.g., polycarbonate, polystyrene, or ABS), composite material (e.g., fiberglass, carbon fiber composite), etc.

There may be embodiments of the invention where the housing does not include the casing, the top and/or bottom covers, and even some variants where the housing is absent at all.

Configuration of the laser unit (12) is depicted in FIGS. 3 and 4. The assembled laser unit (12) is shown in FIG. 3. Components of the laser unit (12) are shown in FIG. 4. The laser unit (12) comprises a laser source (121), a collimator (122), a scanning system (123) with a control device (124), and a focusing system (125).

In the illustrative embodiment of the invention, the laser source (121) with the collimator (122) is a pulsed ytterbium fiber laser with nominal wavelength of 1064 nm, pulse duration of 80-140 ns, pulse repetition rate of 30-60 kHz, pulse energy of 0.8-1.0 J, and average power of 20 W.

In other embodiments of the invention, any other fiber laser with suitable energy, optical, electrical, and structural parameters may be used as the laser source (121) with the collimator (122). Additionally, the invention may employ lasers of different types or with different types of resonators, such as based on Bragg mirrors, Bragg gratings, ring resonators, etc.

In the illustrative embodiment of the invention, the scanning system (123) with the control device (124) comprises a galvanometer scanner with aperture of 10 mm. It scans a defined spatial area using a laser beam with a two-dimensional beam trajectory. Beam deflection in two orthogonal directions is achieved using tilting mirrors with electromagnetic actuators (so-called galvanic mirrors). Electrical signals generated by the control device (124) and fed to the mirror's electromagnetic actuators allow for forming the required trajectory.

The control device (124) enables compensation of geometric distortions of the laser beam trajectory caused by imperfections in geometry of optical elements (lenses, mirrors, prisms, gratings, etc.) of the laser unit (12), inevitable deviations in positions of these elements relative to each other due to limited accuracy of their manufacturing and assembling, displacements caused by changes in operating conditions (temperature, pressure, humidity, etc.), polymer material aging, and other reasons. Examples of possible geometric distortions are shown in FIG. 11, where the top-left image depicts undistorted geometry of the laser beam trajectory. To ensure accuracy of the laser beam trajectory in view of the geometric distortions, calibration of the laser unit (12) is provided, as described in details below.

In other embodiments of the invention, any other galvanometer-type scanner with suitable power, optical, electrical, and structural parameters may be used as the scanning system (123) with the control device (124). Additionally, a scanner of a different type, for example, with a piezoelectric drive for moving optical elements based on prisms, equipped with a corresponding control device, may be used in the invention.

In the illustrative embodiment of the invention, the focusing system (125) comprises a lens with focal length of 254 mm and provides focusing the laser beam in the working plane.

In other embodiments of the invention, any other lens with suitable optical and structural parameters may be used in the focusing system (125).

Configuration of the air filtration unit (13) is shown in FIGS. 5 and 6. The air filtration unit (13) as assembled is depicted in FIG. 5, while the air filtration unit (13) in exploded view is shown in FIG. 6. In the illustrative embodiment of the invention, the air filtration unit (13) comprises an exhaust fan (131), a filter housing (132), a filter cover (133), and a filtering element (134).

In the illustrative embodiment of the invention, the air filtration unit (13) provides air circulation within the enclosed working volume of the apparatus (1) by use of the exhaust fan (131) and cleaning this air from smoke, gases, vapors of removed materials, and other contaminants using the replaceable filtering element (134) containing a mechanical filtering material and an adsorbent filtering material. The air cleaning efficiency within the working volume and the sealed configuration of the housing (11) enable operation of the apparatus (1) in industrial, laboratory, office, educational, and even residential environments under usual ventilation conditions. The mechanical filtering material may be of classes F5 (EU5), F6 (EU6), F7 (EU7), F8 (EU8), F9 (EU9) according to EN 779 (DIN 24184/DIN 24185). The adsorbent filtering material may contain activated charcoal, organosilicon sorbent, etc., in granular form or in form of fibers, sprayed layer, etc. Filters of other types, such as catalytic, photocatalytic, electrostatic, etc., may also be used, depending on the materials to be processed and the required performance of the apparatus (1).

In other embodiments of the invention, the air filtration unit (13) may have a different configuration; for example, instead of the exhaust fan, a blow fan may be used.

It should be noted that, in the case of providing and maintaining a different gaseous medium within the working volume of the apparatus (1), such as consisting of one or more chemically inert gases, the air filtration unit (13) can provide cleaning this gaseous medium from smoke, gases, vapors of removed materials, and other contaminants, similar to what is described above regarding air cleaning. Examples of such gases may include nitrogen and argon.

It should also be noted that embodiments of the invention are possible, where the air filtration unit (13) is absent. In particular, the apparatus (1) without the housing (11) or with the housing (11) that is not sealed may do not include the air filtration unit (13). Such an apparatus (1) can be used in an exhaust enclosure or under an exhaust hood having sufficient performance.

In the illustrative embodiment of the invention, configuration of the movable worktable (14) is presented in FIGS. 7 and 8. The worktable (14) as assembled is shown in FIG. 7, while the worktable (14) in exploded view is shown in FIG. 8. The worktable (14) comprises a housing (141) with a front panel (142), a drive (143), a base (144), a printed circuit board (145) with optical sensors, a plate (146), and a cover (147).

The movable worktable (14) extends from the apparatus (1) to accommodate and fix the PCB blank (3) on it and retracts into the apparatus (1) for processing this blank (see also FIG. 18). Motion of the worktable (14) is provided by the electric drive (143), which, in the illustrative embodiment of the invention, may be a servo drive or may be implemented based on a stepper motor or a linear motor. In other embodiments of the invention, the drive (143) may be implemented, for example, as a pneumatic or hydraulic drive. During processing of the blank, the worktable (14) remains stationary.

There may be embodiments of the invention, where the worktable (14) is stationary all the time, and access to it for placing and retrieving the PCB blank is provided, for example, by absence of the housing (11) or its casing, by easily removable, detachable, or sliding design of the housing (11) or its casing, or by presence of a door or a hatch in the housing (11). The stationary table simplifies design of the apparatus (1) with a tradeoff of its usability.

The blank (3) is placed and fixed on the worktable (14) so that one of its flat sides faces the laser unit (12). This side undergoes processing by the laser beam. If fabrication of the PCB from the blank (3) requires processing the other flat side, the blank (3) can be removed from the apparatus (1) and then placed and fixed on the worktable (14) so that the other flat side faces the laser unit (12).

The invention also does not exclude possibility of flipping the blank (3) from one side to the other without removing it from the apparatus (1) and without detaching it from the worktable (14). In this case, the worktable (14) may contain a pivot unit that flips the blank (3) from one side to the other side to process the latter after processing the former.

Optical sensors (148) located along perimeter of the worktable (14) are used for calibrating the laser unit (12). In the illustrative embodiment of the invention, eight optical sensors (148) based on IR photodiodes are mounted on the printed circuit board (145). The printed circuit board (145) is installed on the bottom side of the plate (146) in such a way that a photosensitive element of each sensor is positioned under a corresponding translucent or semitransparent insert (149). The upper surface of the insert (149) is located at the same level as the upper side of the plate (146), and the lower surface of the insert (149) faces the optical sensor (148) at a short distance from it (see FIG. 9). The insert (149) is made of a ceramic material, partially transmitting, partially diffusing and absorbing light, and serves to protect the sensor from mechanical damage and damage from laser radiation. Additionally, the insert (149) may act as a light filter, preventing penetration of radiation with wavelengths different from the operating wavelength of the laser source (121) to the sensor. The function of the light filter can be crucial in the case of implementing the apparatus (1) without the housing (11) or its casing, where external light sources can cause noise, interference, and malfunctions during operations of the optical sensors (148). The size of the insert (149), visible from the top side of the plate (146), is hereinafter referred to as the aperture of the radiation sensor.

In other embodiments of the invention, the number and design of optical sensors may be different. In particular, four optical sensors may be used, which are located at the corners of the plate (146). The insert (149) may be made of a polymer or glass material. Additionally, the insert (149) (or its functional equivalent) may be structurally integrated with the optical sensor (148). In some embodiments of the invention, the insert (149) may be absent at all.

FIG. 10 shows the controller (15) and the power supply (16) of the apparatus (1) according to the invention. In the illustrative embodiment of the invention, the controller (15) is an electronic unit based on a printed circuit board, mounted on a supporting metal plate and configured to control operations of the apparatus (1). Design of the controller (15) is typical for devices of this kind, so its description is omitted for brevity.

The power supply (16) is an electronic unit configured to supply power to other elements of the apparatus (1). It may be any suitable secondary power source, which electrical, structural, and functional characteristics meet the needs of other elements of the apparatus (1). The power supply (16) may include several power sources (in particular, in FIG. 10 it includes two power sources). Design of the power supply (16) is typical for devices of this kind, so its description is omitted for brevity.

### Method of Calibrating the Laser Unit

The calibration algorithm (2) is depicted in FIG. 12. It comprises steps S21-S24 executed by a processor, where the processor may be a central processing unit (CPU), a graphics processing unit (GPU), a field-programmable gate array (FPGA), an application-specific integrated circuit (ASIC), a single-chip computer, a microcontroller (MCU), or any other hardware or software/hardware means capable of implementing the algorithm (2).

To perform the steps of the algorithm, processor(s) of at least one of the following devices may be used: a control computer that is external to the apparatus (1), the controller (15), and the control device (124). Different steps of the algorithm may be executed by different processors, and some steps may be executed jointly by multiple processors.

The calibration algorithm (2) begins with step S21: Approximate determination of position of each optical sensor in the laser beam coordinate system.

Initially, a signal level of each sensor is determined in the absence of laser radiation. This signal is considered to be noise, and its level (Un) is taken as the zero level (see FIG. 13). Then, position of the sensor is determined by scanning the surface of the worktable along two directions, by the X-coordinate and by the Y-coordinate. To expedite the calibration procedure, search for each sensor begins from an expected position, which can be calculated theoretically, based on the known configuration of the worktable or can be assumed to be equal to the position determined during the previous calibration.

In the illustrative embodiment of the invention, when a noticeable increase in the signal level of the sensor is detected when the beam moves along the first coordinate axis, the value along this coordinate axis is taken as the first coordinate of the approximate sensor position. If no noticeable increase in the signal level of the sensor is detected within a predefined range of values of the first coordinate, the beam is shifted along the second coordinate axis by a predetermined increment, and scanning along the first coordinate axis continues.

For the approximate determination of the sensor's position, it may be sufficient for the signal level of the sensor to exceed a threshold value (Uₜ) for one reading or for several consecutive readings of this signal. If the signal level of the sensor exceeds the threshold value for several consecutive readings of this signal while one coordinate is changed, the value of this coordinate may be taken as the average value (K_{avg}) for the coordinate (K₁) of the first reading and the coordinate (K₂) of the last reading (see FIG. 13), and the value of the other coordinate may be taken as the current (last changed) value. When both coordinates change simultaneously, the average value may be determined for both coordinates.

In different embodiments of the invention, the trajectory of the beam movement may vary, for example, with alternating changes in coordinates, as shown in FIG. 14, part A or FIG. 14, part B. Simultaneous changes in two coordinates are also possible, for example, to implement a spiral trajectory of beam movement, as shown in FIG. 14, part C, or a zigzag trajectory of beam movement, as shown in FIG. 14, part D. In some cases, for example, during initial search for the sensor (when its expected position is calculated theoretically), it may be efficient to use a method of random generation of coordinate pairs with a scattering center located in the expected sensor position (e.g., the Monte Carlo method), as shown in FIG. 14, part E.

It should be noted that, in the drawings, for case of understanding, a continuous sensor signal is typically presented, but in practice, the sensor signal may be discretely sampled. In particular, when using a pulsed laser, the sampling frequency of the sensor signal may be equal to the frequency of pulse generation by the laser source or may be a fraction of this frequency, for example, the sensor signal may be sampled upon generation of every second or every tenth pulse of the laser radiation. This depends on the dimensions of the working area of the apparatus, the number of sensors, the required speed, etc.

The calibration algorithm (2) then continues at Step S22: Refinement of the coordinates determined at step S21.

At this step, the position of the sensor determined in the previous step is taken as the expected position, and the coordinates are determined again. The same method of determining the sensor coordinates as in the previous step may be used, but with a smaller scanning step, or a different method may be used.

In the illustrative embodiment of the invention, to expedite the calibration procedure, a “crisscross” method of refining coordinates is applied. In this method, the first coordinate is fixed equal to the corresponding coordinate determined at step S21, while the second coordinate is varied within a predetermined range of values, overlapping possible errors of step S21 (see FIG. 15). The value of the second coordinate may be determined similar to what was described earlier with reference to FIG. 13. Then, the second coordinate is fixed at this determined value, and the first coordinate is varied within a predetermined range of values, overlapping possible errors of step S21. The value of the first coordinate may also be determined similar to what was described earlier with reference to FIG. 13.

The calibration algorithm (2) then continues at step S23: Refinement of the coordinates determined at step S22.

At this step, the position of the sensor determined in the previous step is taken as the expected position, and the coordinates are determined again. In the illustrative embodiment of the invention, for precise determination of the center coordinates of the sensor, an iterative “circular” method of refining coordinates is used. In this method, the beam moves along a circle with a center at the point, which coordinates were determined in the previous step and with a radius exceeding the aperture radius of the sensor (see FIG. 16).

If the sensor signal level does not exceed the threshold value along this path, the radius of the circle is decreased by a first predetermined amount. This reduction amount may be, for example, 1/10 or 1/20 of the circle radius. If the sensor signal level exceeds the threshold at some point, then, at the next iteration of this step, the center of the circle is shifted towards this point by a second predetermined amount, and simultaneously the radius of the circle is decreased by a third predetermined amount.

The first, second, and third predetermined amounts are determined to ensure the convergence of the iterative process at step S23. Various approaches may be used for determining these amounts. For example, one approach could involve a “smooth” approximation towards the target value from one side of the coordinate axis (as shown in FIG. 16), while another approach could involve using a “fork” approach for sequential approximation towards the target value from different sides along the coordinate axis. These approaches can be used synchronously or independently along different coordinate axes.

In general, the iterative process described above continues until the magnitude of the change in the refined coordinates at each iteration becomes less than a predetermined value or until the beam trajectory precisely follows the boundary of the sensor aperture, which is determined by the characteristics of the sensor signal level. Alternatively, the iterative process may stop when the beam trajectory approximately follows the boundary of the sensor aperture, but the centers of the beam trajectory and the sensor aperture essentially coincide, which is also determined by the characteristics of the sensor signal level.

The calibration algorithm (2) then continues at Step S24: Determination of coordinate transformation function.

After determining the precise coordinates of all sensors in the laser beam coordinate system, the coordinate transformation function is calculated. The coordinate transformation function links the coordinates of the sensors in the laser beam coordinate system, determined by the method described above, with the actual physical coordinates of these sensors in the coordinate system of the apparatus (1), which are known from the configuration and dimensions of the plate (146).

The laser beam coordinate system may generally represent an arbitrary coordinate system and may be predefined by the manufacturer of the laser unit (12). In particular, the laser beam coordinate system may be a polar coordinate system. The coordinate system of the apparatus (1) may also generally represent an arbitrary coordinate system. In particular, the coordinate system of the apparatus (1) may be a Cartesian coordinate system. The coordinate transformation function allows controlling the laser beam with the necessary precision.

In the illustrative embodiment of the invention, the coordinate transformation function is applied by a processor outside the apparatus (1) when generating control signals for the apparatus (1), which are received and processed by the controller (15), and then used to control the laser unit (12) and the worktable (14). In another embodiment of the invention, the coordinate transformation function may be applied by the controller (15) or the control device (124), or jointly by the controller (15) and the control device (124).

The calibration algorithm (2) is performed upon the initial activation of the apparatus (1) and subsequently as needed. For example, it may be performed upon each activation of the apparatus (1), upon each installation and fixation of the blank (3) on the worktable (14), upon each movement of the movable worktable (14) to the working position, upon flipping the blank (3) with or without extraction from the apparatus (1), or periodically, after a predetermined operating time of the apparatus (1), and so on.

It should be noted that the above-described calibration algorithm may also be applied to other devices and systems having an optical system similar to the optical system of the laser unit (12) of the apparatus (1). For example, devices for precise processing such as laser ablation, laser drilling, laser engraving, laser cutting, laser welding, laser cleaning, laser oxidation, laser heat treatment (like quenching, tempering, normalization), and the like may undergo calibration. Commonly, the calibration procedure in such devices is performed manually. Application of the described automatic calibration method allows significantly speeding up the calibration process, reducing its complexity, and increasing reliability by eliminating the human factor.

### PCB Blank

The apparatus (1) is configured for processing blanks (3) of printed circuit boards (see FIG. 17). In general, the PCB blank (3) comprises a flat insulating base coated with a conductive layer on both sides, which, in turn, is covered with a thin insulating layer (so-called “protective mask”).

Thickness of the insulating base of the blank (3) can range from approximately 0.5 mm to approximately 5 mm, depending on the purpose of the printed circuit assembly, the prototype of which needs to be manufactured. In particular, thickness of the insulating base may depend on the design of the printed circuit assembly and mechanical requirements applied thereto. Thickness of the conductive layer can range from approximately 5 μm to approximately 60 μm, depending on the purpose of the printed circuit assembly. In particular, thickness of the conductive layer may depend on the current values in the printed conductors formed in the conductive layer and on the permissible voltage drop across these conductors.

The insulating base can be made of an insulating material with suitable physical, electrical, and chemical parameters. In particular, the insulating material can be ceramic (based on aluminum oxide or zirconium oxide) or glass-ceramic (polycrystalline glass, also known as sitall). The insulating material can also be a laminated plastic (phenolic), a composite material (textolite, glass-textolite, polymer-ceramic), fluoropolymer, polyimide, etc.

The conductive layer on each side of the insulating base can be a metal foil with suitable physical, electrical, and chemical parameters. In particular, silver, copper, aluminum, nickel, chromium, and metal alloys can be used in the material of the conductive layer.

The protective mask layer may be a relatively thin insulating layer (usually with a thickness of 5 to 100 μm), performing protective functions during mounting circuit elements, for example, by reflow or wave soldering method. In particular, dry film photoresist or liquid photoresist based on epoxy acrylate polymer can be used as the material of the protective mask layer.

In the illustrative embodiment of the invention, the blank (3) is a copper-foiled aluminum or zirconium ceramic sheet and it has a nominal thickness of 1 mm with a nominal foil thickness of 17.5 μm.

The dimensions of the blank (3) in the plane are limited by the dimensions of the landing spot of the worktable (14) and may correspond to a certain dimensional range with predetermined increments in size along two coordinates. In the illustrative embodiment of the invention, the minimum size of the rectangular blank (3) on each side is 22.86 mm, and the maximum size is 99.06 mm with the size increment of 15.24 mm. The scope of the invention includes blanks (3) of printed circuit boards of any size and shape that can be loaded into the apparatus (1). In particular, the dimensions of the blank (3) may correspond to standardized sizes of printed circuit assemblies, such as Arduino, PC/104, Eurocard (IEC-297/IEC-60297), etc.

FIG. 17 shows configuration of the blank (3), containing mounting (fastening) holes (A, B, C) at the corners, metal-plated through-holes (D), arranged in two rows along three sides of the blank (3), and metal-plated through-holes (E), located with a specified pitch in free area of the blank (3).

The blanks (3) are pre-manufactured in advance at a factory and processed on the apparatus (1) by the method described below to produce prototype electronic printed circuit assemblies based on them. It should be noted that the apparatus (1) allows producing not only prototypes but also small batches of printed circuit assemblies, if production speed is crucial and economic production indicators are less important.

Mounting holes (A, B, C) are intended for fixing the blank (3) on the worktable (14) for processing and subsequently for fixing the PCB assembly in place during its operations. An example of arranging the blank (3) on the worktable (14) is shown in FIG. 18. The blank (3) is secured using pillars (H) inserted into holes (G) of the plate (146). In the illustrative embodiment of the invention, the holes (G) of the worktable (14) are spaced with pitch of 15.24 mm, and their mutual arrangement corresponds to arrangement of the mounting holes (A, B, C) of the blanks (3) of corresponding sizes. To compensate possible inaccuracies in the manufacturing and positioning the blank (3), diameter of the hole (B) may be slightly larger than diameter of the hole (A), and the hole (C) may have an oval shape elongated along the diagonal in the direction of the hole (A) (see fragment (F) in FIG. 17). In the illustrative embodiment of the invention, the hole (A) has diameter of 2.6 mm, the hole (B) has diameter of 2.8 mm, and the hole (C) has size of 2.6×2.8 mm. In other embodiments of the invention, sizes of holes (A, B, C) may be different, for example, from 1.0 mm to 10 mm, depending on the design requirements of the corresponding printed circuit boards.

It should be noted that instead of the mounting holes (A, B, C) for securing the blank (3), other mounting elements may be used, such as slots of a predetermined shape interacting with fixing members of a corresponding configuration. Examples of such fixing members may include latches, clamps, etc. In some embodiments of the invention, edge sections of the printed circuit board may function as the mounting elements.

The holes (D) of the blank (3) are intended for mounting electrical connectors of the printed assembly or for soldering external wire connections, but they can also be used as interlayer connectors. Contact pads with corresponding windows in the protective mask layer can be formed around them. The conductive layer of the holes (D) and their contact pads may have a corrosion-resistant coating, for example, based on gold or palladium. In the illustrative embodiment of the invention, the hole (D) has diameter of 1 mm, and distance between parallel rows of the holes (D) is 2.54 mm. In other embodiments of the invention, the hole (D) may have a different diameter, for example, 0.25 to 3.0 mm, and/or the holes (D) may have a different pitch, in particular, corresponding to requirements for mounting a corresponding electrical connector (e.g., using the press-fit technology) or for soldering corresponding wire connections. Some of the holes (D) may have a diameter different from the diameter of the other holes (D). Some of the holes (D) may have a pitch that is different from the pitch of the other holes (D).

The holes (E) of the blank (3) are intended for use as interlayer connectors. For this purpose, when routing connections of the PCB assembly, the printed conductor is provided to the hole (E) from both sides of the blank (3), and a conductive strap is left around the hole (E), as it is usually done when implementing metal-plated through-holes on printed circuit boards. In the illustrative embodiment of the invention, the hole (E) has diameter of 0.3 mm. In other embodiments of the invention, the hole (E) may have a different diameter, for example, 0.1 to 1.0 mm, depending on thickness of the blank (3). In the illustrative embodiment of the invention, pitch of the holes (E) along two coordinates is 5.08 mm. In other embodiments of the invention, pitch of the holes (E) may be different, for example, depending on the number of interlayer transitions to be implemented. Pitch of the holes (E) may differ for different portions of the blank (3), for example, it may be larger or smaller in the central portion than in the peripheral portion. Pitch of the holes (E) may differ along two coordinates.

It should be noted that, in addition to using metal-plated through-holes (D, E), another technology may be employed for providing interlayer connection. In particular, for this purpose, a through-hole may be formed in the material of the blank (3) by means of the apparatus (1), around which contact pads are formed on both sides of the blank (3). A short conductor (so-called “jumper”) or a rivet is inserted into such a hole, which is then soldered on both sides of the blank (3). This method allows interlayer connections to be made at arbitrary locations on the blank (3), without being tied to pre-defined positions of the holes (D, E).

The above description pertains to blanks for double-sided printed circuit boards containing two conductive layers. However, the blank (3) can be a blank for a multi-layer printed circuit board containing more than two conductive layers, for example, three, four, five, or six conductive layers. In this case, the metal-plated through-holes (D) and/or (E) may connect more than two conductive layers.

For example, when implementing the blank (3) for a four-layer printed circuit board, the first group of the metal-plated through-holes (E) may connect layers 1 and 2, the second group may connect layers 1 and 3, the third group may connect layers 1 and 4, the fourth group may connect layers 2 and 3, the fifth group may connect layers 2 and 4, and the sixth group may connect layers 3 and 4. In another example of implementing a four-layer printed circuit board blank (3), the first group of metal-plated through-holes (E) may connect layers 1, 2 and 3, the second group may connect layers 1, 2 and 4, the third group may connect layers 1, 3 and 4, the fourth group may connect layers 2, 3 and 4, and the fifth group may connect layers 1, 2, 3 and 4. The same approach can be extended to the metal-plated through-holes (D) if necessary. Each group of holes (D, E) may contain one or more corresponding metal-plated through-holes. The arrangement scheme of various types of holes (D, E) of the blank (3) in terms of the conductive layers they connect is predefined and taken into account when designing and manufacturing the printed circuit board based on the blank (3).

If a certain type of metal-plated through-hole (D, E) connects only internal conductive layers (located inside the insulating base) or internal and external conductive layers, then the external contact pad of such a hole may be separated by an insulating gap from the external conductive layer with which it shall not be connected. Such an insulating gap can be formed either beforehand-during production of the blank (3) before its processing in the apparatus (1), or during its processing in the apparatus (1).

Examples of internal conductive layers may include solid or meshed power layers, e.g., “analog ground”, “digital ground”, “ground”, “shield”, etc. It shall be clear that these examples are provided for illustration purposes only and are not limiting.

It should be noted that the blank (3) can also be a blank for a single-sided printed circuit board, in which case its configuration may be simplified accordingly.

### Method of Processing the PCB Blank.

In the illustrative embodiment of the invention, the apparatus (1) operates as follows. After the apparatus (1) is powered on, a signal is sent from the control computer to extend the worktable (14) to the position for loading the blank (3). In another embodiment of the invention, this signal may be generated within the apparatus (1), e.g., upon pressing a button or a key, or upon touching a touchpad. The blank (3) is placed and secured on the worktable (14) using the pillars (H) in a predetermined position corresponding to the blank size. Then, the worktable (14) is moved inside the apparatus (1) to occupy its working position upon command from the control computer or another control device. Design and precision of manufacturing and assembling the worktable (14), including its drive, ensure positioning the blank (3) within the working volume of the apparatus (1) with a required accuracy. If necessary, calibration of the laser unit (12) is performed by the method described above.

In embodiments of the invention with a stationary worktable (14), its extension and retraction are not applicable, and the blank (3) is placed and secured on the worktable (14) owing to absence of the housing (11) or its part that obstructs access to the worktable (14), or by opening, shifting, or rotating the housing (11) or its part that closes access to the worktable (14).

The control computer contains data regarding the connections and pads on the PCB to be manufactured by the apparatus (1). These data are preloaded into the control computer. In the illustrative embodiment of the invention, Gerber X2 format data is used. In other embodiments of the invention, other data formats may be used, both common (e.g., Gerber RS-274X, IPC-2581, or ODB++ for conductors; Excellon, Sieb & Meyer, or NC Drill for holes) and proprietary. The control computer provides control signals to the apparatus (1), which are received by the controller (15). The controller (15) is connected to the drive (143) of the movable worktable (14), to the fan (131) of the air filtration unit (13), and to the control device (124) of the scanning system (123) of the laser unit (12) and it controls these units (if they present in the apparatus (1)).

The laser beam in the operating mode moves along a trajectory determined based on the connections data of the PCB, and vaporizes the conductive layer of the blank (3) at its focusing point. Parameters of the laser beam (wavelength, pulse energy, pulse duration, pulse repetition frequency) correspond to the materials used in the blank (3), including insulating material and conductive material.

In particular, when using insulating material based on aluminum oxide or zirconium oxide and conducting material based on electrical copper, a fiber laser with nominal wavelength of 1064 nm, approximate pulse duration of 100 ns, pulse repetition frequency of approximately 50 kHz, and pulse energy of approximately 1.0 J can be applied. When using other materials in the blank (3), such as fiberglass or polyimide film as the insulating material, aluminum or silver as the conducting material, the laser irradiation parameters mentioned above may vary.

To expedite processing the blank (3), the laser beam removes the conducting material to its entire thickness (down to the insulating material) to form insulating gaps between the conductors of the PCB wide enough, leaving isolated “islands” of conducting material untouched in unused areas of the PCB. Of course, it is possible to remove all the conducting material in unused areas of the PCB, but this requires more time and energy and leads to accelerated equipment wear. The laser beam can remove the conducting material not to its full thickness but to a portion of its thickness, for example, half, one-third, or one-quarter. This requires less laser power per pulse and contributes to more uniform distribution of heat in the blank (3), but requires more processing time.

In some cases, the remaining “islands” of conducting material may be irradiated by the laser in such a way as not to vaporize the conducting material but only to heat it to such a degree as to disrupt its adhesion to the insulating material. After this, the conducting material of the “islands” may delaminate by itself or may be mechanically removed with application of slight forces.

In the protective mask layer, windows are provided by the laser beam at the locations of the contact pads for the schematic elements of the PCB. The parameters of the laser beam are adapted to perform this task. In particular, the laser power per pulse when providing windows in the protective mask layer may be significantly lower compared to the power when forming a conductive pattern by vaporizing the conducting material.

The above-described actions relate to one side of the blank (3). After their execution, the blank (3) is flipped so as the top side and the bottom side are reversed, and similar actions are performed regarding the other, yet unprocessed, side of the blank (3). In the described and illustrated examples of the invention, processing is carried out on the top side of the blank (3); however, in other examples, processing may be performed on the bottom side of the blank (3) with a corresponding modification of the apparatus (1) design.

An example of a finished PCB manufactured on the apparatus (1) is shown in FIG. 19, and an enlarged fragment of this PCB is shown in FIG. 20, where insulating gaps (I) forming a conductive pattern, open contact pads (J), and conductor pass to the other side of the PCB through a hole (E) can be distinguished.

If necessary, holes, slots, cutouts, recesses, indentations, and other elements of various (including non-rectangular) shapes may be made in the PCB. The edge of the PCB may also undergo processing to achieve the required contour, such as straight or curvilinear. This processing may be performed before or after forming the conductive pattern of the PCB and/or opening windows in the protective mask. The parameters of the laser beam are adapted to accomplish this task. In particular, the laser power per pulse and the pulse frequency during laser drilling of holes and laser milling of the PCB edge may be maximized to expedite processing.

In accordance with the operating mode of the laser unit (12), the operating mode of the air filtration unit (13) may be set. For example, with increasing load of the laser unit (12), performance of the fan (131) of the air filtration unit (13) may synchronously increase. Such a change in the operation mode of the air filtration unit (13) may be controlled by the controller (15).

In view of conical nature of focusing the laser beam due to intrinsic characteristics of the focusing system (125), through-holes may be made in two stages, which are performed on different sides of the blank (3). The stages of laser drilling and their results are shown in FIG. 21. In the first stage (FIG. 21, part A), during processing the PCB blank (3) from one side, the conical laser beam (K) vaporizes the material so as diameter of the resulting hole with a conical wall (M) at half the depth of the hole corresponds to the nominal diameter of the planned hole with a cylindrical wall (L). The result of the first stage is a conical hole (FIG. 21, part B). In the second stage (FIG. 21, part C), the same laser beam, during processing the blank (3) from the other side, also vaporizes the material so as diameter of the resulting hole with a conical wall (M) at half the depth of the hole corresponds to the nominal diameter of the planned hole with a cylindrical wall (L). The result of the second stage is a bi-conical hole (FIG. 21, part D), diameter of which at its minimum section matches the nominal diameter of the planned hole.

Similarly, processing the PCB edge may be performed across the entire thickness of the blank (3) if an oblique cut (i.e., a cut with an acute angle) is unacceptable or undesirable. It should be clear that the conicity of the laser beam in FIG. 21 is exaggerated for clarity.

The sequence of actions described in the above practical examples of implementing the invention is illustrative and it does not limit the protection scope of the invention. Some actions may be performed simultaneously or in a different sequence if it is physically possible and does not hinder achievement of the invention's purpose and attainment of the technical result.

The spatial indications used here (e.g., top, bottom, upper, lower, left, right, etc.) refer to position and orientation of corresponding elements in their normal, usual, or working position or state of the apparatus (1) and/or its parts and/or the blank (3). If such spatial indications refer to some elements, when they are shown outside of this apparatus, they shall be understood as if these elements were shown inside this apparatus.

Numerals (e.g., first, second, etc.) referring to nouns merely indicate some distinction between these nouns and do not imply any real numbering, classification, ranking, labeling, etc. of the corresponding elements.

It should also be appreciated that various modifications, adaptations, and alternative embodiments thereof may be made within the scope and spirit of the present invention. The invention is further defined by the following claims.

What is claimed is:

1. An apparatus for Printed Circuit Board (PCB) manufacturing, comprising:
a worktable comprising a plurality of optical sensors and a mounting surface for placement of a PCB blank,
wherein the mounting surface permits mounting the PCB blank onto it such that a position of the PCB blank in a coordinate system of the worktable is definitively known;
a laser unit; and
a controller connected to the worktable and the laser unit, and configured to calibrate the laser unit by determining positions of the optical sensors in a coordinate system of the laser unit in at least two degrees of freedom and by determining a coordinate transformation function,
wherein the coordinate transformation function links any physical coordinates in the coordinate system of the worktable with coordinates in the coordinate system of the laser unit, and the coordinate transformation function is configured for using to control a laser beam during processing of the PCB blank.

2. The apparatus of claim 1, wherein the apparatus is configured to perform any of: providing a window in a protective mask, removing a conductor layer from an insulating base of a PCB blank, forming recesses in the PCB blank, creating through-holes in the PCB blank, and trimming the PCB blank along a contour of a predetermined shape.

3. The apparatus of claim 1, wherein the worktable is configured to move to a PCB blank loading position before placement and fixation of the PCB blank, and to a working position after placement and fixation of the PCB blank.

4. The apparatus of claim 1, wherein the worktable provides placement and fixation of the PCB blank in a first orientation and in a second orientation that is different from the first orientation, so that processing of the PCB blank started in the first orientation can be continued in the second orientation.

5. The apparatus of claim 4, wherein the calibration of the laser unit is performed prior to the start of processing the PCB blank in the first orientation and prior to the continuation of processing the PCB blank in the second orientation.

6. The apparatus of claim 1, wherein the laser unit provides removal of a layer of material from a PCB blank, the layer of material comprising at least one of the following materials: metal, ceramic, glass-ceramic material, polymer-ceramic composite, polymer-glass composite, polymer-organic composite, polymer.

7. The apparatus of claim 6, wherein the removal is provided by evaporation, and the apparatus further comprising a housing enclosing the worktable, and a filtration unit that filters a gaseous medium within the housing, wherein the gaseous medium is contaminated due to the evaporation.

8. The apparatus of claim 7, wherein the gaseous medium comprises air.

9. A method of calibrating a PCB manufacturing apparatus that includes a worktable with optical sensors and a laser unit, the method comprising the following steps:
determining positions of the optical sensors in a coordinate system of the laser unit in at least two degrees of freedom; and
determining a coordinate transformation function that links any physical coordinates in a coordinate system of the worktable with coordinates in the coordinate system of the laser unit.

10. The method of claim 9, wherein the step of determining positions comprises the following steps:
approximate determination of the position of each optical sensor;
a first refinement of the position determined in the step of approximate determination; and
a second refinement of the position determined in the first refinement step.

11. The method of claim 10, wherein the first refinement of the position is performed using a “crisscross” method, where a laser beam moves along a linear path.

12. The method of claim 10, wherein the second refinement of the position is performed using a “circular” method, where a laser beam moves along a circular path.

13. The method of claim 9, wherein the step of determining positions is performed sequentially along two coordinates in an apparatus coordinate system.

14. The method of claim 10, wherein the step of determining positions is performed simultaneously along two coordinates in an apparatus coordinate system.

15. The method of claim 10, wherein the step of determining positions is performed while changing a position of a laser beam sequentially along two coordinates in an apparatus coordinate system.

16. The method of claim 10, wherein the step of determining positions is performed while changing a position of a laser beam simultaneously along two coordinates in an apparatus coordinate system.
